(19) United States
(12) Patent Application Publication
(10) Pub. No.: US 2025/0316182 A1
(43) Pub. Date: Oct. 9, 2025

(54) SYSTEMS AND METHODS FOR A SIMULATION SYSTEM

(71) Applicants: Steven E. SHAW, Prosper, TX (US); Sean Patrick CAWLEY, Olive Branch, MS (US)

(72) Inventors: Steven E. SHAW, Prosper, TX (US); Sean Patrick CAWLEY, Olive Branch, MS (US)

(21) Appl. No.: 18/627,947

(22) Filed: Apr. 5, 2024

(51) Int. Cl. G09B 9/00

(52) U.S. Cl. CPC G09B 9/003

(57) ABSTRACT

Devices, methods, and systems are described for physical simulations of real-world situations in a controlled environment that may include a shooting device coupled to a vehicle that may emit, fire, or discharge an object, and a target vehicle that emits an envelope to receive the object and cause a hit of the target when a directional or omnidirectional signal is emitted by the shooting vehicle.

### BACKGROUND OF THE INVENTION

### Field of the Invention

The present invention relates generally to computer systems, communication systems, and/or vehicle systems that may be used to simulate real-life situations. More specifically, the invention provides methods, systems, and techniques for controlling vehicles located in a physical environment, such as land, water, or air, and controllable in one or more directions to simulate applications involving targets.

Video games and virtual reality applications are known to simulate certain real-world applications, such as driving on land, flying, and traveling by water. Each of these applications typically involves a console, joysticks, and/or head gear connected via hardwire or wirelessly and are played in a confined environment such as in a home, office, or arcade. These games, toys and entertainment systems may also be played interactively among children and adults. Such devices may also provide tactile coordination and interactivity. However, there are no environmental concerns, such as wind, water, forces of acceleration and gravity, or physical objects interfering with the simulation of real-world applications.

Target-type games also exist. One common game is known as laser tag. Existing laser tag games do not provide the use of devices other than a fake gun shooting infrared beams (IR). There has been no significant attempt to include mobile, wireless, acceleration, gyroscopic or other opportunities into laser tag. Further, existing laser tag games require clear lines of sight before the IR beams can be shot at each other.

With laser tag systems, players wear a target receiver on their body and carry a gun emitter. If a participant points their gun at the target receiver of another participant and pulls the trigger, a signal is transmitted. If the signal is received by the target receiver, a valid hit is then achieved.

With simulation systems, such as laser tag, where participants are not lodging actual projectiles (like bullets) at each other, the system tries to replicate such models through electronic and digital signals and receivers. The target is an infrared (IR) receiver and the gun is an IR transmitter. The shooter must point their gun at the target and shoot their signal such that the IR receiver detects the signal.

In more dynamic and complex settings, environmental factors can further disrupt signals that are intended to simulate physical projectiles. Most formalized arenas for laser tag include low or no light levels to maximize signal transmission and receipt reliability by the emitters and receivers. Such low-light environments are not achievable in outdoor real-world settings, which precludes the application of laser tag systems to vehicles operated outdoors, such as on water.

One real world example includes military applications, such as “dog fighting” in which military fighter jet pilots try to target each other in aerial applications. Real-world applications to maximize training effectiveness and efficiency can be expensive, dangerous, and complex. Accordingly, there is a need to provide such training in a safer and less expensive physical environment in which target simulations can also accommodate for real-world physical conditions.

### SUMMARY

In one aspect, a system for simulating a game on one of water, land, and air, comprising: a first vehicle including a first weapons system, first pilot controls, and a first communication system; the first weapons system firing an object; a second vehicle including a target system including an emitter for emitting a target envelope, wherein the target system detects a hit signal when the object is located inside the target envelope.

The first vehicle and the second vehicle may be personal watercraft. The first vehicle may be controlled remotely via a wireless controller using one of RF, Bluetooth, and wireless.

The hit signal includes one of a wireless data signal, an audio signal, physical impact, and a visual indication of an impact. The object may be transmitted using one of a gun, a laser, RADAR, radio signals, optical signals, infrared (IR) signals, physical contact, microwave signals, Bluetooth, and wireless.

The target system may be received by the first vehicle and wherein the first vehicle may transmit one of a directional and an omnidirectional signal after receiving the target envelope. The emitter of the weapons system may include one or more components to one of launch physical projectiles, transmit and receives electronic signals, and spray a high pressure water stream.

A computer control sensor platform may be part of the first vehicle and may include one of a shot counter, GPS, accelerometer, a gyroscope, a video recorder, an audio recorder, and sensors that detect movement and status of the weapon system including one of velocity, angle, pitch attitude, magnetic heading, and others; shots, decoys, and health points remaining.

The weapons system further comprises a decoy switch to launch a decoy, and the the target system may include a target that is one of a physical, electronic, and a digital structure.

The target system may include a hit detection system. The first vehicle may include a hit indicator signal including one of lights, sounds, wireless signals, smoke, projectiles, and visual indicators that are activated when a valid hit signal is determined through physical contact, digital or electronic emission detection and processed by a hit detection system target controller.

One of the first and second vehicles further comprises a pilot controller that includes a computer system that receives and transmits pilot signal inputs and translates them into outputs that drive responsive actions in the weapon system.

In another aspect, a vehicle for simulating a game on one of water, land, and air, comprising: a first weapons system, first pilot controls, and a first communication system; the first weapons system firing an object upon receiving a target envelope and emitting one of an omnidirectional and a directional hit signal when the object is located inside the target envelope.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates a vehicle system in an embodiment.

FIG. 2 illustrates a weapon system diagram in an embodiment.

FIG. 3 illustrates a target system in an embodiment.

FIG. 4 illustrates a pilot system in an embodiment,

FIG. 5A-5D illustrate a vehicle each with a target in various embodiments.

FIG. 5E illustrates a target system in an embodiment.

FIG. 5F shows a system with an unmanned ariel vehicle in an embodiment.

FIG. 6 illustrates an active electronic target system in an embodiment.

FIG. 7 shows a passive electronic target system in an embodiment.

FIG. 8 shows a flow diagram of a target system in accordance with one or more embodiments that are shown in FIGS. 5A-5E.

FIG. 9 shows a flow diagram of an active electronic system in accordance with FIG. 6 in an embodiment.

FIG. 10 shows a flow diagram of a passive electronic system in accordance with FIG. 7 in an embodiment.

FIG. 11 shows a flow diagram of a system in accordance with FIG. 5F.

### DETAILED DESCRIPTION

Each of the additional features and teachings disclosed below can be utilized separately or in conjunction with other features and teachings to provide a device, system, and/or method for a target-based simulation in a physical environment. Representative examples of the present invention, which utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense and are instead taught merely to particularly describe representative examples of the present teachings.

Moreover, the various features of the representative examples and the dependent claims may be combined in ways that are not specifically and explicitly enumerated to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for original disclosure, as well as for the purpose of restricting the claimed subject matter.

Devices, methods, and systems are described for physical simulations of real-world situations in a controlled environment that may include one or more of 1) a shooting device coupled to a vehicle that may emit, fire, or discharge an object such as a paintball, or 2) a target that emits an envelope to receive the object and cause a hit of the target

In some embodiments, several aspects of basic airplane formation flying, tactical maneuvering, and the basics of aerial combat may be introduced and practiced using watercraft such as personal watercraft. Some advantages may include comparative speeds and maneuvering characteristics of personal watercraft that allow two or more personal watercraft to always be in visual range of one another while executing specified training maneuvers. In some cases, complex multi-dimensional maneuvering concepts for fighter aircraft may be confined within a single plane of motion on the surface of the water which substantially and accurately simulates aerial maneuvering at a single altitude, resulting in a simpler operating environment for introducing complicated concepts.

A wake of the watercraft provides a visual representation of the craft's motion through the water, allowing clear and immediate feedback of the relative motion of two watercraft, particularly during turning motion. Such feedback is not available in modern smokeless jet engine aircraft moving through the invisible air mass.

In one embodiment, a vehicle may include any vehicle that may be used in water, air, or on land. In one embodiment, a vehicle may be operated remotely. In one embodiment, the vehicle may be operated remotely using a wireless controller using RF, Bluetooth, wireless, or other frequency bands, with knobs, levers, and/or buttons to steer the vehicle and operate the pilot control system components. The controller may maneuver the shooting vehicle relative to the target vehicle in order to prevent a hit or achieve a shot on the other vehicle target system.

In one embodiment, a hit may include a wireless data signal, an audio signal, physical impact, or a visual indication of an impact. The object may be transmitted using a gun that shoots an object, such as a paintball, laser, RADAR, radio signals, optical signals, infrared (IR) signals, physical contact, microwave signals, Bluetooth, or wireless (e.g., 802.11).

In one embodiment, a target device may be coupled to a target vehicle and may emit an envelope signal that is received by a receiver on a shooting vehicle, thereby causing the shooting vehicle to hit the first device by emitting a hit signal when a button, pedal, lever or similar device is activated inside the envelope signal. The envelope signal may be an audible or visual signal that mimics the shooting vehicle having a missile lock on the target vehicle. This causes the shooting vehicle to shoot at and hit the target vehicle and releases a broadcast hit signal that is received by the target vehicle.

In one example, a device with an IR emitter may be coupled to a target vehicle, such as a personal watercraft, or car, such as a go kart, that sends an envelope signal to an IR receiver on a shooting vehicle, such as a personal watercraft or car, such as a go-kart to simulate firing a weapon in aerial combat e.g., dogfighting.

In another embodiment, a Bluetooth or other wireless signal may be sent from a vehicle and received by a device on land in visual range, where the land-based device responds to the signal by opening, revealing information, or displaying lights in accordance with a game, such as a game requiring the collection of clues dispersed throughout a body of water.

In another embodiment, the simulation may include a vehicle, such as a closed course involving go-karts, where an integrated screen on the vehicle displays artificial images as if they were present in the real world as part of an adventure or mystery game. In some embodiments, each player may be configured with a virtual reality camera.

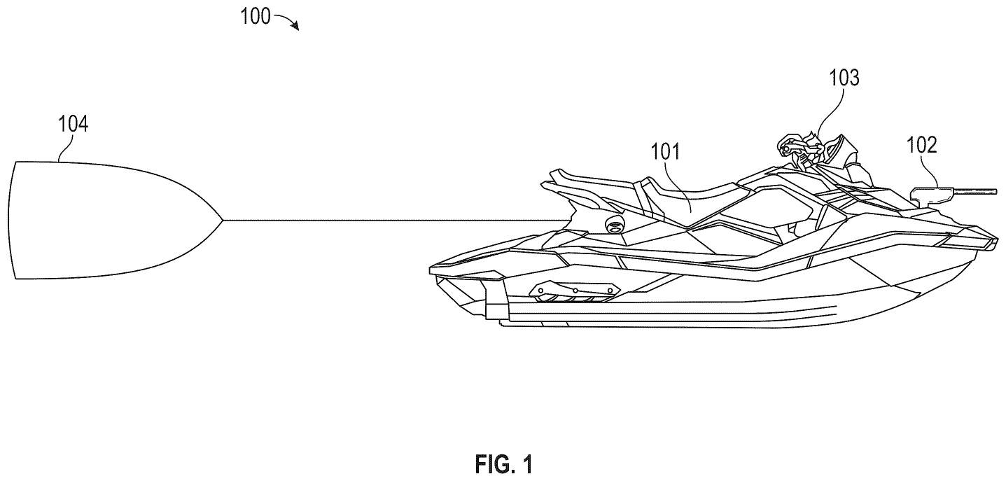

FIG. 1 show a vehicle system 100 in an embodiment. The system 100 may include a vehicle 101 and a target 104. The vehicle 100 may be a water, land, air, or space vehicle. In one embodiment, the vehicle 101 may be displaced by applying a cumulative net force generally opposite to the direction of movement. The system 100 may also include a weapon system 102, which may be an electronic emitter or receiver, or projective launcher mounted to the front of the vehicle 100 with internal controls, such as power supply, computer controller, safety switch, and a trigger switch.

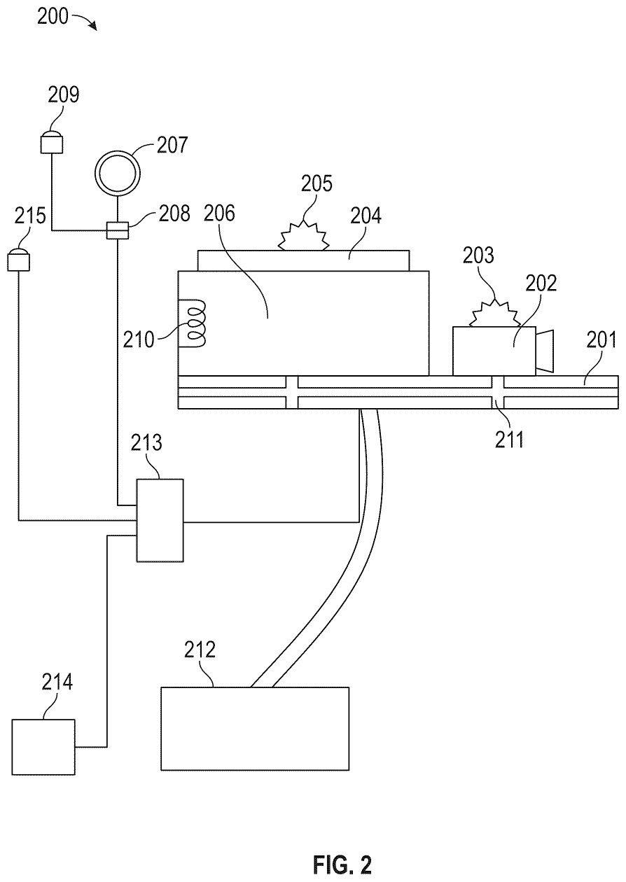

The system 100 may also include pilot controls 103 including a collection of displays, controls, switches, and/or buttons needed to activate, manage, control, and deactivate the vehicle, weapon system 102, and pilot control system 103. The system 100 may also include a target system 104 with an electronic receiver, optical, audible, or physical detection system that is digital, or physically attached to the vehicle, transmitted from the vehicle, or towed from the vehicle, which determines whether or not that the target has been hit. Such a hit may be referred to as a “valid hit.” In some embodiments, a wireless controller may remotely control the pilot controls. In other embodiments, the target system may include a balloon that pops when there is a valid hit. FIG. 2 shows a weapon system 200 in an embodiment. The system 200 may include an emitter 201 that include a barrel, transmitter, or receiver device that launches physical projectiles, transmits, or receives digital/electronic signals, or sprays a high pressure water stream that provides a sufficient pressure may be detected and processed by a target system and determine a “shot” has been fired.

The system 200 may also include a camera 202 that records what the emitter sees. In one embodiment, the camera 202 may be mounted to the barrel of the weapon system 102 or integrated inside it to capture video and other parameters aligned with where the weapon system 102 is pointed. In one embodiment, the camera 202 may apply an overlay onto the visual image indicating vehicle, weapon system, and target system information and parameters. The system 200 may also include a shoot light 203 having a visual, audible, and/or digital indicator that activates when the emitter is activated. The system 200 may also include a computer control sensor platform 204. The platform 204 may include a shot counter, GPS, accelerometer, a gyroscopic, a video recorder, an audio recorder, and/or sensors that detect movement and status of the weapon system 200 such as velocity, roll angle, pitch attitude, magnetic heading, and others; shots, decoys, and/or health points remaining.

The system 200 may also include an arming/safety light 205, which may include a visual, audible, and digital signal that indicates if the weapon system 200 is armed or disarmed. If the weapon system 200 is armed then it can emit “shot” signals or projectiles based on pilot inputs and controls. If the weapons system 200 is “safe” or not armed, then it cannot emit “shot” signals or projectiles.

The system 200 may also include a projectile storage and loading container 206. In one embodiment, if physical projectiles are used to indicate shots, then the projectiles may be stored in an integrated storage container that feeds at sufficient rate into the emitter or barrel area of the weapon system 200. In one embodiment, a storage and feed container may be watertight, and either be permanently attached to the emitter section or separate and connectable of the weapon system 200.

The system 200 may also include an arming switch 207 with a bracelet, switch, proximity sensor, wired, or wireless platform that indicates and controls whether the weapon system 200 can emit or launch shoot signals or projectiles The system 200 may also include an arming switch 208 that may be a proximity sensor, magnetic, wired, wireless or other form of switch or latch that indicates and controls whether the weapon system 200 can emit or launch shoot signals or projectiles.

The system 200 may also include a trigger 209 having a switch, button, or controller that sends a signal to the emitter 201 to launch, activate, or emit a shoot signal. In one embodiment, the trigger may be part of the pilot controls 103.

The system 200 may include a dehumidifier 210 that may be embedded in the projectile storage and loading container 206 to minimize or remove moisture, humidity, or water from the container 206. In some embodiments, the dehumidifier 210 may be chemical, electrical, thermal, or physical absorber to ensure all liquid or vapor is removed from the projectile storage container 206.

The system 200 may also include water drainage lines 211 to serve as cavities, conduits, and/or drainage pathways integrated and embedded within the weapon system 200 to allow water, liquid, vapor, or humidity to be dispelled or diverted out of the emitter 201 and weapon system 200 when fired or otherwise operated so that the internal components and structures remain relatively dry.

The system 200 may also include a propellent source 212 having pressurized gases, liquid, or other compressor, or source of projectile-force medium that is stored, prepared, and/or released to provide the driving force for the weapon system emitter. The propellant source 212 may be attached or separate from the vehicle 100. In one embodiment, the system 200 may contain a reservoir or storage area to properly prepare the projectile force medium for emission. In one embodiment, an integrated air compressor and reservoir built-in to the vehicle and driven by the vehicle engine to provide unlimited pressurized air to power the gun may be used. The pressurized air may either be provided continuously, or on demand, when certain conditions are met, the compressor activates until sufficient air is available. The conditions may include one or more of 1) if the pressurized air level in the reservoir falls below a certain PSI; 2) when the engine exceeds a predetermined RPM; or 3) if the compressor is activated and pressurized air is pumped into the reservoir. In one embodiment, once sufficient pressurized air is present in the reservoir, the air compressor may de-activated. Even if sufficient air is not yet re-established, in the event that RPM drops below the predetermined level, the compressor may deactivate, until RPM is increased again.

The system 200 may also include a controller 213 that includes a computer system that receives and transmits pilot signal inputs and translates them into outputs that drive responsive actions in the weapon system 200. For example, a trigger input signal is processed and commands the weapon system 200 to emit a shoot signal or projectile. The controller 213 may draw electrical power from source 214 to control a function of a weapon system 200. The system 200 may also include a power source 214 that may be a battery or engine-driven electrical power to support current and voltage requirements for the weapon system 200.

The system 200 may also include a decoy switch 215. The decoy switch 215 may be a switch, button, or controller that sends a signal to the emitter 201 to launch, activate, or emit a “decoy” signal. The trigger 208 may be part of the pilot controls 103. The decoy can be a physical, electronic, wireless, digital, or virtual signal that invalidates a valid detected or received hit signal.

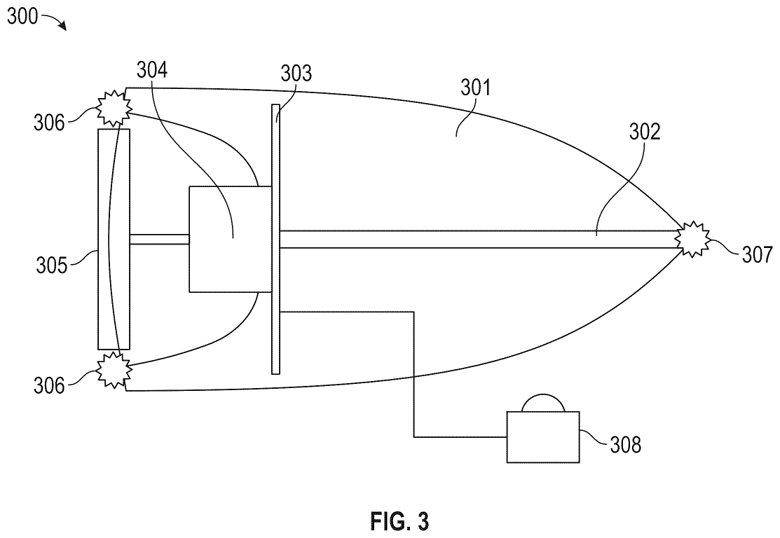

FIG. 3 shows a target system 300 in an embodiment. The system 300 may include a target 301. In some embodiments, the target 301 may be a physical, electronic, or digital structure that is the aimpoint of the opponent “shot” signal. The target 301 may be physically, electronically, or virtually attached, tether, towed, or co-located with the vehicle. The system 300 may include a target skeleton 302 which may have an internal physical structure to transmit physical or electronic signals throughout the target system, and to provide structural support to the target 301.

The system 300 may also include a hit detection system mounting plate 303. The mounting plate 303 may be a physical platform on which hit detection system components are mounted and may provide structural support to the target 301.

A hit detection system target controller 304 may be included in the system 300 and include a computer, sensor, power, and/or networking systems that determine target hit status, and then transmit that information to the vehicle system 101 and weapon system 102. The detection system 304 may include physical contact switches, camera vision, pressure switches, and/or electronic emission detection systems such as radar or infrared.

The system 300 may include a target plate 305 that is the physical region that defines where valid “hits” occur on the target system 300. This can be an integrated component of the hit detection system target controller 304 or a separate region that solely defines where a valid “hit” occurs.

A hit indicator signal 306 may be lights, sounds, wireless signals, smoke, projectiles, and/or visual indicators that are activated when a valid hit signal is determined through physical contact, digital or electronic emission detection and processed by the hit detection system target controller 304.

The system 300 may include forward indicator signals 307 such as lights, sounds, wireless signals, smoke, projectiles, or visual indicators that are activated when a valid hit signal is determined through physical contact, digital or electronic emission detection and processed by the hit detection system target controller 304, and presented to the front of the target system 300, primarily to inform that pilot of the target vehicle, such as vehicle 101, that they have received a valid hit signal.

The system 300 may include a decoy switch 308, which may include a switch, button, or controller that sends a signal to the target system 300 to launch, activate, or emit a decoy signal. The trigger 208 may be part of the pilot controls 103. The decoy can be a physical, electronic, wireless, digital, or virtual signal that invalidates a valid detected or received hit signal.

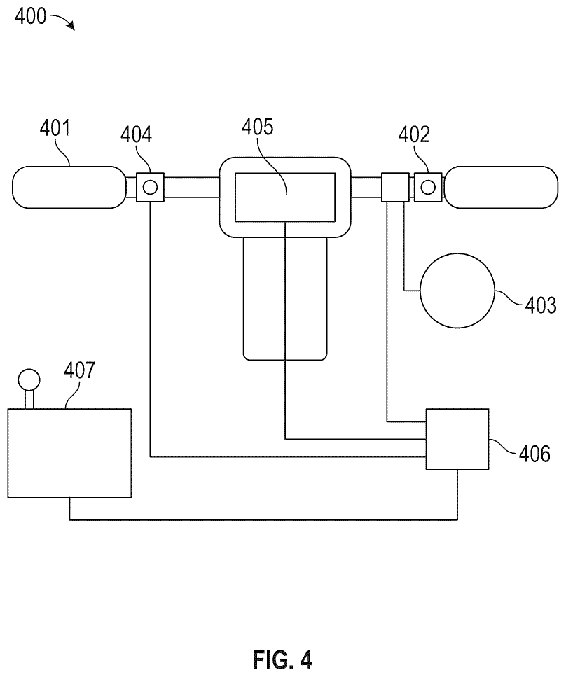

FIG. 4 shows the pilot controls 400 in an embodiment. The pilot controls may include a vehicle control 401 that has handles, control stick, yoke, and/or steering wheel, used to control the displacement vector of the vehicle 101.

The system 400 may include a trigger 402 such as a switch, button, or controller that sends a signal to the emitter to launch, activate, or emit a shoot signal. The trigger 402 may be part of the pilot controls 103.

The system 400 may include an arming switch 403 with a bracelet, switch, proximity sensor, wired, and/or wireless platform that indicates and controls whether the weapon system 200 can emit or launch “shot” signals or projectiles.

The system 400 may include a decoy switch 404, which may a switch, button, or controller that sends a signal to the target system 400 to launch, activate, or emit a decoy signal. The trigger 402 may be part of the pilot controls 103. The decoy can be a physical, electronic, wireless, digital, or virtual signal that invalidates a valid detected or received hit signal.

The system 400 may also include pilot display 405, which may include a digital, electronic, or virtual display to present vehicle, weapon system, and/or target system status, parameters, or other information to the pilot.

A controller 406 may include a computer system that receives and transmits pilot signal inputs and translates them into outputs that drive responsive actions in the weapon system 200. For example, a trigger input signal is processed and commands the weapon system to emit a “shot” signal or projectile. The 406 controller draws electrical power from source 213 to control the weapon system 200.

A target system controller 407 may be a wireless or wired input controller to process input signals, parameters, data, or status information from the target system 300 to the controller in 213. Additionally, the controller may transmit signals, parameters, data, or status information from the vehicle, pilot controls 103, or weapon system to the target system 300. For example, a decoy switch activation may be wirelessly transmitted to the target system 200 to activate the decoy process at the physical target system location.

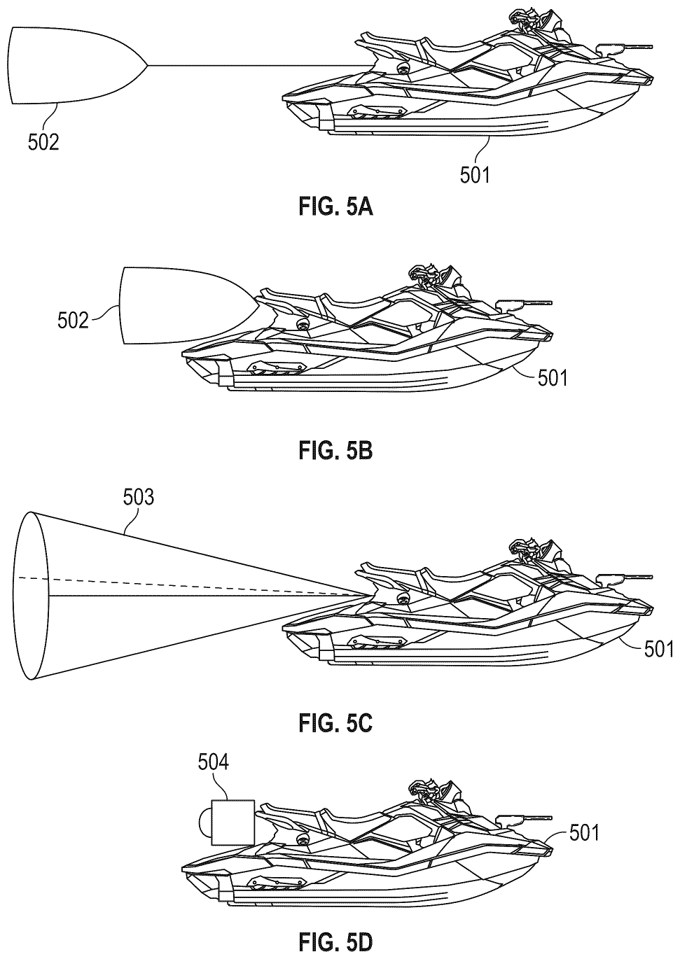

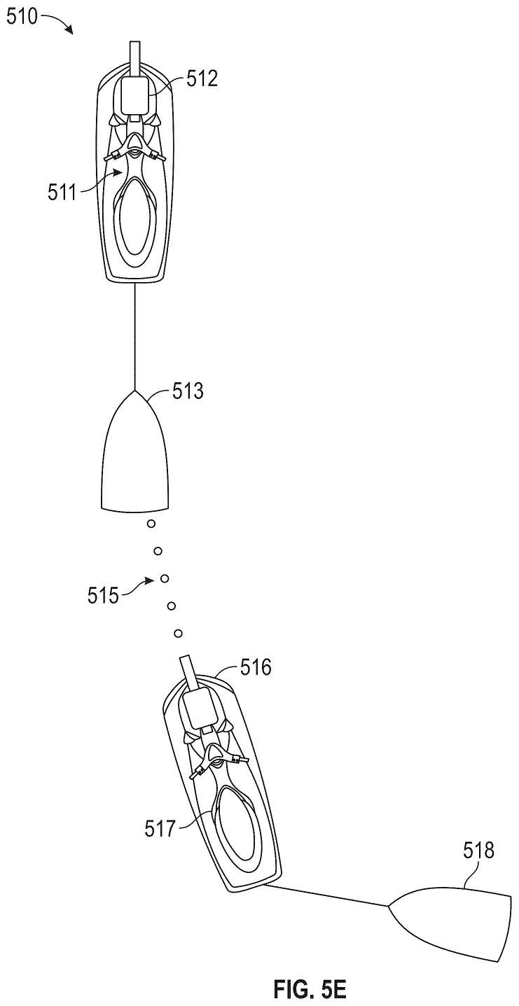

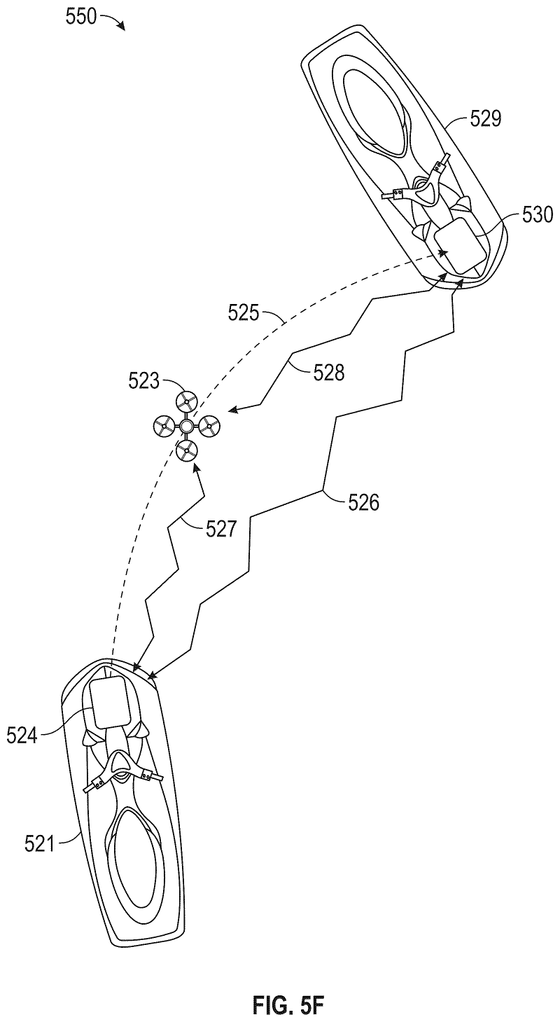

FIG. 5A-5D illustrate a vehicle 501 each with a target in various embodiments. It should be noted that the vehicle 501 may be a target vehicle or a shooting vehicle or both. In FIG. 5A, the vehicle may include a tethered or towed target 502 not physically co-located with the vehicle 501. FIG. 5B shows a vehicle 500 that includes a target 502 physically connected or co-located with the vehicle 501. FIG. 5C shows a vehicle 501 that may have active electronic target envelope transmitter that emits a target envelope signal 503, which may be received by another vehicle to determine if the other vehicle is within the target envelope 502. FIG. 5D shows a vehicle 501 that may have a passive electronic target envelope receiver 504, which requires an active transmission signal from another vehicle weapon system to be detected. In one embodiment, the transmission signal may be infrared, laser, or wireless.

FIG. 5E shows a target system 510 in an embodiment. The system 510 may include a target vehicle 511 with a weapon system 512 and a target 513 and a shoot vehicle 517 with a weapon system 516 and a target 518. In one embodiment, the shoot vehicle 517 may shoot at target 513 using projectiles 515 while vehicles 511 and 517 travel across a medium, such as water, land, or air.

FIG. 5F shows a system 550 with an unmanned vehicle in an embodiment. The system 550 may include a shooter vehicle 521 and a target vehicle 529. Each vehicle may also act as either a target vehicle or a shooter vehicle in other embodiments. Vehicle 521 may include a weapons system 524 and vehicle 529 may include weapons system 530. The weapon systems 524, 529 may be substantially the same as system 300.

The system 550 may also include a missile simulator such as a drone or other airborne self-propelled controllable vehicle 523 with a flight profile 525. The vehicle 523 may fly a profile 525 from the shooter vehicle 521 to the target vehicle 529, tracking the target vehicle 521, either driving towards it and following it, or stopping in flight to simulate successful missile defense maneuver, out of range, missile malfunction, or missile fail to track. The profile 525 may also include flying to a reference recovery point or returning to the shooter vehicle 521.

The system 523 may include a two-way datalink 526 between vehicles to share vehicle information to support missile simulator system. A two-way data link 527 datalink connection between shooter vehicle 521 and vehicle 523 to send commands to the vehicle 523 or for the vehicle 523 to provide status information back to the shooter vehicle 521. In other embodiments, a two-way datalink connection 528 between target vehicle 529 and vehicle 523 may be provided to support missile simulator tracking target vehicle 521, to include position, speed, heading, and use that information by missile simulator to determine appropriate profile to fly.

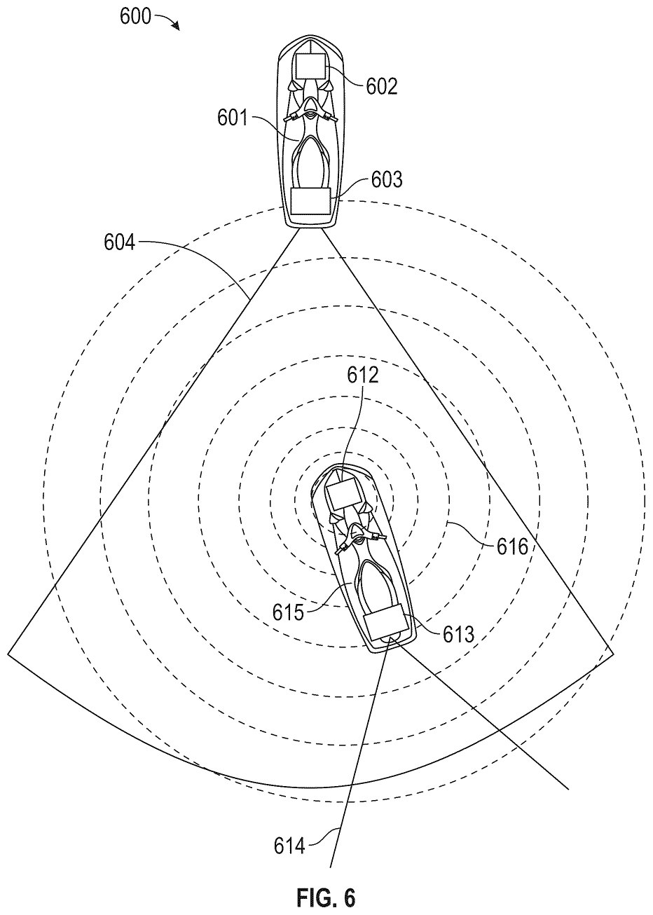

FIG. 6 shows an active electronic target system 600 which may include a target vehicle 601. In one embodiment, the target vehicle 601 may be the vehicle that may receive the hit signal. The hit signal indicates to the target vehicle that it has been hit by the shooter vehicle 615.

The system 600 may include a weapon system 602. In one embodiment, the weapon system 602 is an electronic emitter and receiver that transmits an omni-directional hit signal when the shooting vehicle 615 is receiving the active electronic target envelope signal 604 and the pilot presses the trigger button with all other requirements met (such as, but not limited to, shots remaining, weapon system armed, and shooter vehicle being alive).

Active electronic target envelope transmitter 603 may include a transmitter device that emits a prescribed envelope signal with predetermined size and shape parameters, such as +/−90° horizontal, +/−30° vertical, and within 50 feet of range of the transmitter.

An active electronic target envelope signal 604 may refer to an actual size and shape of the transmitted envelope signal. The system 600 may also include a shooter vehicle 615 that is capable of transmitting the hit signal.

The system 600 may include a hit signal 616.—When certain required conditions have been met (including but not limited to active electronic target envelope signal received by the shooter vehicle, the weapon system is armed, the shooter vehicle is alive, and the shooter vehicle pilot presses the trigger button) an omni directional hit signal 606 is transmitted by the weapon system 602 to indicate the target vehicle has been hit. The hit signal may include signal data to indicate which vehicle's active electronic target envelope signal 604 was detected. It should be noted that the omni-directional signal 606 may include specific data on a specific target vehicle and/or envelope signal so that incorrect hit signals are not processed by non-target vehicles. The shooting vehicle 615 may include a weapon system 612, an emitter 603 that emits an active electronic target signal 614. It should be noted that the shooting vehicle 615 and the target vehicle 601 may be a target vehicle, shooting vehicle, or both depending on the number vehicles in the system 600.

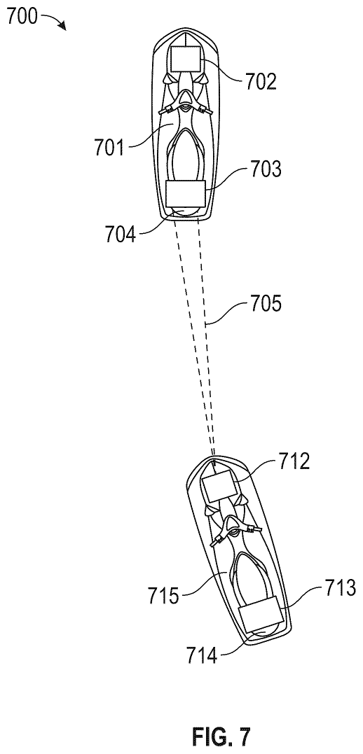

FIG. 7 shows a passive electronic target system 700 in an embodiment. The system 700 may include a target vehicle 701. In this embodiment, the target vehicle 701 is the vehicle that will receive the hit signal. The hit signal indicates to the target vehicle 701 that it has been hit by the shooter vehicle 715.

A weapon system 702 may be included in the system 700. In a passive electronic target system configuration, the weapon system 702 acts as an electronic emitter and receiver that transmits a directional shoot signal when the target vehicle is the shooting vehicle. The vehicle may also include a receiver 704 for receiving a received signal and computer controller 703 may process the received signal.

The shooting vehicle 715 may have a weapon system emitter in a weapon system 712 that may be pointed at the passive electronic target system controller and envelope receiver 703 and the pilot presses the trigger button with all other requirements met (such as, but not limited to, shots remaining, weapon system armed, and/or shooter vehicle is alive). A signal 705, such as an infrared signal, wireless signal, or a laser signal, may be received by receiver 703.

The system may include a target system controller and envelope receiver 703, which may be a wireless or wired input controller to process input signals, parameters, data, or status information from the target system to the controller in 213. Additionally, the controller 703 may transmit signals, parameters, data, or status information from the vehicle, pilot controls, or weapon system to the target system. For example, a decoy switch activation may be wirelessly transmitted to the target system to activate the decoy process at the physical target system location.

In this embodiment, the receiver may determine a valid hit signal. A passive electronic target envelope receiver 704 may also be included that detects shoot signals originating from predetermined specified positions relative to the target vehicle. For example, the passive electronic target envelope receiver 704 may only receive shot signals emitted from +/−45° of the back of the target vehicle. Any shoot signals emitted from outside this angular position would not be detectable by the receiver.

The system 700 may also include a shooter vehicle 715 that may transmit the shot signal. The system 700 may also include a shoot signal 705 that may be a wireless, electronic, focused transmission representing a shot from the shooter vehicle. The beamwidth of the shoot signal may be constrained to within +/−3° of the transmitter. The signal may carry shooter vehicle identifying information, carrier data, and other information that is processed by the target system controller. It should be understood that 703, 704 are substantially the same 713, 714, respectively depending on if the vehicle is a target vehicle or a shooting vehicle.

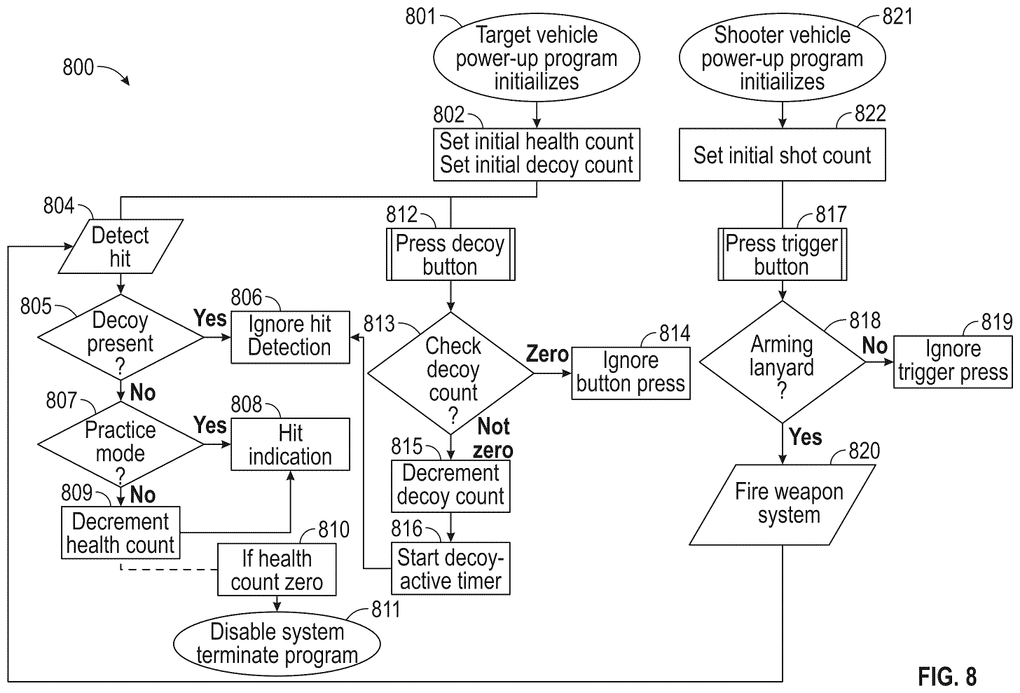

FIG. 8 shows a flow diagram of a target system 800 in accordance with one or more embodiments that are shown in FIGS. 5A-5D. At step 801 for the target vehicle, the system 800 powers-up and the playing program initializes and an initial decoy and health count are set at step 802. At step 803, a hit detection is monitored. At step 804 it is determined if a hit is detected. At step 805, if a decoy was present, at step 806, the hit detection is ignored. If at step 805 no decoy is present, then at step 807 it is determined if the system is in practice mode. If yes, then a hit indication is determined at step 808. If no at step 807, the health count is decreased at step 809. If the health count goes to zero at step 810, the system may be terminated at step 811.

If at step 812, the decoy button is pressed, at step 813, it is determined if the decoy count is zero. If yes, at step 814 the decoy button being pressed is ignored. If at step 813 the decoy count is not zero, the decoy count is decreased. At step 816, the active decoy time is activated and the hit detection is ignored at 806. It should be noted that a decoy is a signal, such an audible signal or a signal that emits a light or a physical object.

For the shooting vehicle, the system 800 initializes and power-up at step 822 and the initial shot count is determined at step 822. At step 817, the trigger button may be pressed. At step 818, it is determined if the arming lanyard is connected, then the weapon system may fire at 820. If not, the trigger press is ignored at step 819. If the weapon is fired at step 820, a hit is detected at step 804.

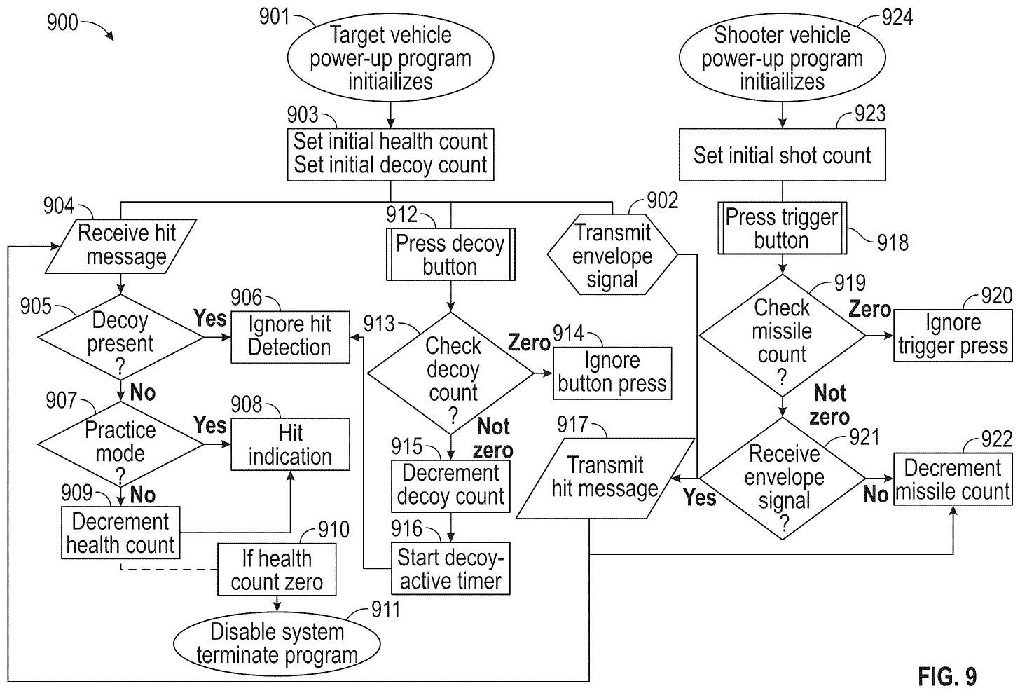

FIG. 9 shows a flow diagram of an active electronic system 900 in accordance with FIG. 6 in an embodiment. At step 901, the system 900 powers-up and the target vehicle initializes and an initial decoy and health count and missile count are set at step 903. At step 902, a transmit envelope signal is initiated. At step 904 it is determined if the other vehicle hit message is received. At step 905, if a decoy was present, at step 906, the hit detection is ignored. If at step 905 no decoy is present, then at step 907 it is determined if the system is in practice mode. If yes, then a hit indication is determined at step 908. If no at step 907, the health count is decreased at step 909. If the health count goes to zero at step 910, the system may be terminated at step 911.

If at step 912, the decoy button is pressed, at step 913, it is determined if the decoy count is zero. If yes, at step 914 the decoy button being pressed is ignored. If at step 913 the decoy count is not zero, the decoy count is decreased. At step 916, the active decoy time is activated and the hit detection is ignored at 906.

For the shooting vehicle, the system 900 initializes and power-up at step 923 and the initial shot count is determined at step 924. At step 918, the trigger button may be pressed. The missile count is checked at 919. If it is zero, the trigger button may be ignored at 920. If the missile count is not zero, it is determined at step 921 if the other vehicle envelope signal is received. If yes, then the hit message occurs at 917 and the missile count is decreased at 922. If no, then the missile count is decreased at step 922. At step 904, the target vehicle may then receive the hit message.

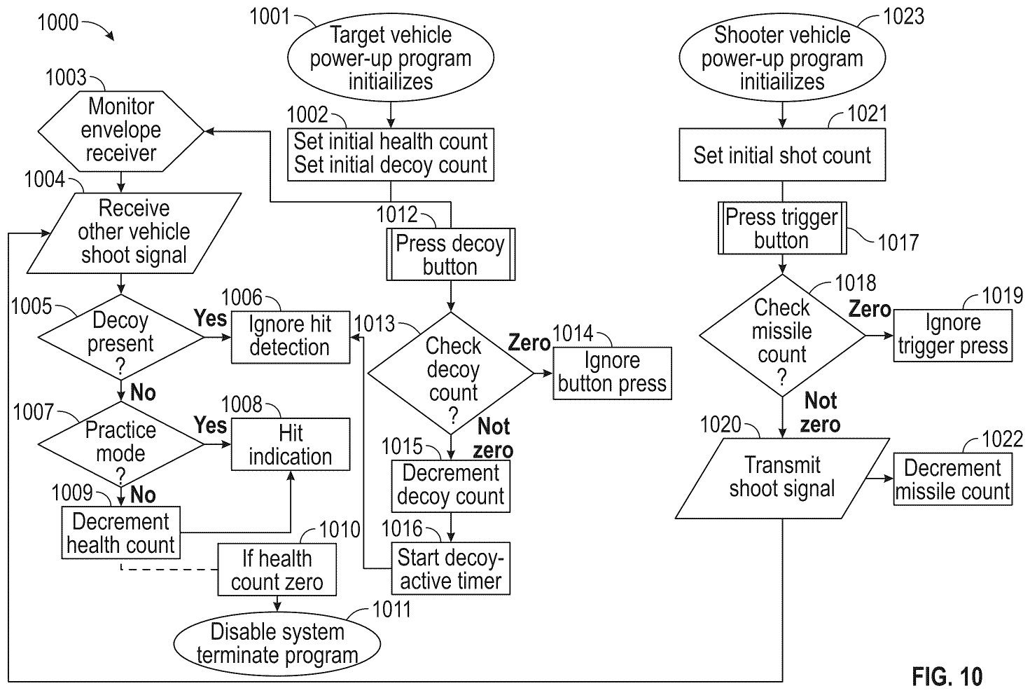

FIG. 10 shows a flow diagram of a passive electronic system 1000 in accordance with FIG. 7 in an embodiment. At step 1001, the system 1000 powers-up and the playing program initializes and an initial decoy and health count and missile count are set at step 1002. At step 1003, an envelope receiver is monitored. At step 1004 it is determined if the other vehicle hit message is received. At step 1005, if a decoy was present, at step 1006, the hit detection is ignored. If at step 1005 no decoy is present, then at step 1007 it is determined if the system is in practice mode. If yes, then a hit indication is determined at step 1008. If no at step 1007, the health count is decreased at step 1009. If the health count goes to zero at step 1010, the system may be terminated at step 1011.

If at step 1012, the decoy button is pressed, at step 1013, it is determined if the decoy count is zero. If yes, at step 1014 the decoy button being pressed is ignored. If at step 1013 the decoy count is not zero, the decoy count is decreased. At step 1016, the active decoy timer is activated and the hit detection is ignored at 1006.

For the shooting vehicle, the system 1000 initializes and power-up at step 1023 and the initial shot count is determined at step 1021. At step 1017, the trigger button may be pressed. The missile count is checked at 1018. If it is zero, the trigger button may be ignored at 1019. If the missile count is not zero, the shoot message may be shot at 1020 and the missile count is decreased at step 1022. At step 1004, the target vehicle may then receive the hit message.

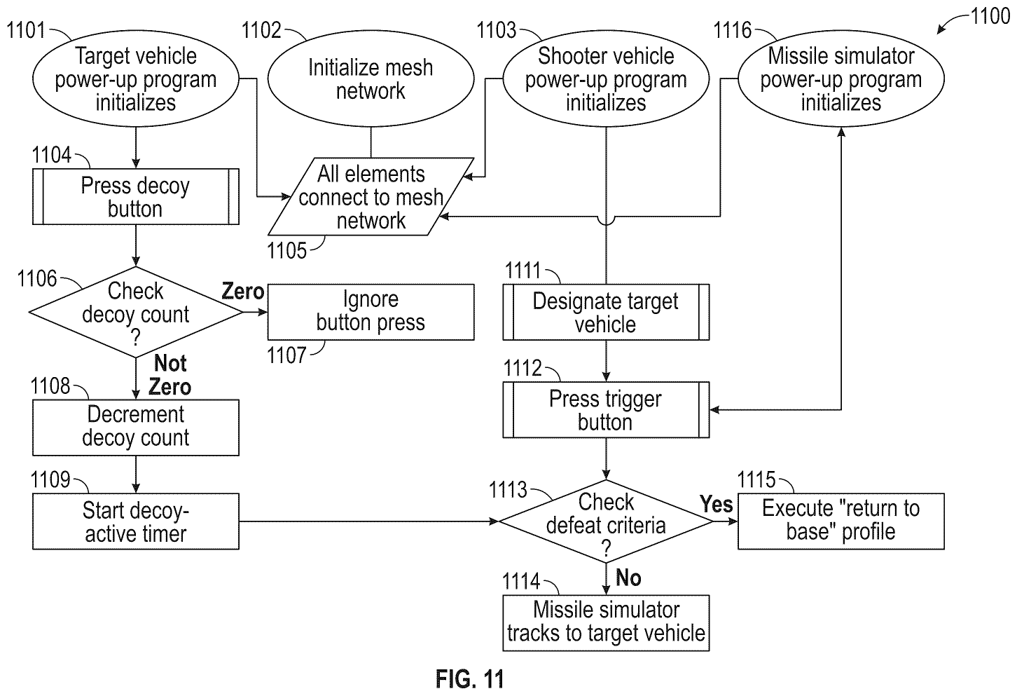

FIG. 11 shows a flow diagram of a system 1100 in accordance with FIG. 5F. At step 1101, the target vehicle powers-up, a mesh network initializes at step 1102, and a shooter vehicle powers-up at step 1103, and a missile simulator system program powers up at 1116. The elements in steps 1101-03 and 1116 connect to the mesh network at step 1105.

At step 1104, a decoy button may be pressed. At step 1106, a decoy count is checked. If the decoy count is zero, the button is ignored at step 1107. If there are decoys available, the count may be decreased at 1108 and a decoy timer is started at step 1109. A target vehicle defense maneuver may be detected at step 1113. At step 1111, a target vehicle may be designated. The shooter vehicle may press the trigger button at step 1112. The system may check for a defeat criteria at step 1113. If yes at step 1113, a return to base profile program may be initiated by the missile simulator at step 1115. If no at step 1113, the missile simulator may track the target vehicle at step 1114. The missile simulator may be similar to vehicle 523. The defeat criteria may include for example: 1) a pre-defined defensive maneuver that meets specific maneuvering parameter criteria as the target vehicle is attempting to avoid the shooter vehicle, 2) the activation of a decoy system, 3) a vehicle being further away than a maximum shot distance available from the shooter vehicle, or 4) where the missile simulator randomly just does not work or track the target vehicle.

A shooter vehicle that controls a missile simulator, a target vehicle, and all three systems may be communicatively connected on a wireless mesh network to share data to include GPS position, speed, heading, health and/or status information

The missile simulator may be a drone, or other self-propelled, steerable, controlled airborne, water, or land-based vehicle. In one embodiment, the missile simulator may be attached to the shooter vehicle, in a separate location from the shooter vehicle, or maneuver along with the shooter vehicle so as to stay in a predetermined proximity to the shooter vehicle. The shooter vehicle may designate or select the target vehicle on a pilot display to identify the target vehicle.

When the shooter vehicle pilot presses the trigger button, the missile simulator determines if missile defeat criteria is present through the mesh network. Missile defeat criteria may be in the form of a successful decoy or defensive maneuver in some embodiments. Successful decoy employment by the target vehicle may be pre-programmed criteria that may include, timing of the decoy and relative position between the shooter vehicle, target vehicle, and/or missile simulator. Successful defensive maneuvers may include pre-programmed criteria encompassing relative position, orientation, and velocities of the shooter, target, and missile simulator at various times throughout the missile simulator profile.

If a successful missile simulator defeat criteria is met then the missile simulator will execute “Return to Base” profile that may consist of staying in place, flying to a predetermined reference point, or returning to a relative position near the target vehicle.

If missile defeat criteria is not present, then the missile simulator will track and drive towards the target vehicle. Successful missile “hit” may consist of actual impact with the target vehicle, maintaining close proximity to the target vehicle, flashing lights, sounds, or ejection of some sort of marking device like a flag, smoke, powder, liquid, etc.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for. 11

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A system for simulating a game on one of water, land, and air, comprising:
a first vehicle including a first weapons system, first pilot controls, and a first weapons system firing an object;
a second vehicle including a target system including an emitter for emitting a target envelope signal, when one of the object is located inside the target envelope signal and a trigger is activated.

2. The system of claim 1, wherein the first vehicle and the second vehicle are personal watercrafts.

3. The system of claim 1, wherein the first vehicle is controlled remotely via a wireless controller using one of radio frequency RF, Bluetooth and a wireless network.

4. The system of claim 1, wherein the hit signal includes one of a wireless data signal, an audio signal, physical impact, and a visual indication of an impact.

5. The system of claim 1, wherein the object is transmitted using one of a gun, a laser, RADAR, radio signals, optical signals, infrared (IR) signals, physical contact, microwave signals, Bluetooth, paint ball device and a wireless network.

6. The system of claim 1, wherein the emitted target envelope signal from the target system is received by the first vehicle and, wherein the first vehicle transmits one of a directional and omnidirectional signal after receiving the emitted signal.

7. The system of claim 1, wherein an emitter of the first weapons system includes one or more components to one of launch physical projectiles, transmit and receives electronic signals, and spray a high pressure water stream.

8. The system of claim 1 further comprising a computer control sensor platform including one of a shot counter, GPS, accelerometer, a gyroscope, a video recorder, an audio recorder, and sensors that detect movement and status of the first weapons system including one of velocity, angle, pitch attitude, magnetic heading shots, decoys, and health points remaining.

9. The system of claim 1 wherein the first weapons system comprises a projectile storage and loading container having a dehumidifier and water drainage lines and a propellent source.

10. The system of claim 1, wherein the first weapons system further comprises a decoy switch to launch a decoy.

11. The system of claim 1, wherein the target system includes a target that is one of a physical, electronic, and a digital structure.

12. The system of claim 1, wherein the target system includes a hit detection system.

13. The system of claim 1, wherein the second vehicle further includes a hit indicator signal including one of lights, sounds, wireless signals, smoke, projectiles, and visual indicators that are activated when a valid hit signal is determined through physical contact, digital or electronic emission detection and processed by a hit detection system.

14. The system of claim 1, wherein one of the first and second vehicles further comprises a computer system that receives and transmits pilot signal inputs and translates them into outputs that drive responsive actions in the first weapons system.

15. A vehicle for simulating a game on one of water, land, and air, comprising:
a first weapons system, and a first pilot controls; the first weapons system firing an object at a target and emitting one of hit signal, an omnidirectional and a directional hit signal when the object and hits the target.

16. The vehicle of claim 15, wherein the first vehicle is controlled remotely via a wireless controller using one of radio frequency (RF)_Bluetooth, and wireless network.

17. The vehicle of claim 15, wherein the hit signal includes one of a wireless data signal, an audio signal, physical impact, and a visual indication of an impact.

18. The vehicle of claim 15, wherein the object is transmitted using one of a gun, a laser, RADAR, radio signals, optical signals, infrared (IR) signals, physical contact, microwave signals, paint ball device, Bluetooth, and wireless.

19. The vehicle of claim 15, wherein the first weapons system further comprises a decoy switch to launch a decoy.

20. The vehicle of claim 15 further compromising a target system, wherein the target system includes a hit detection system.
